(19) United States
(12) Patent Application Publication
(10) Pub. No.: US 2023/0133035 A1
(43) Pub. Date: May 4, 2023

(54) Enhanced Behavioral Monitoring For Network Devices

(71) Applicant: Firemon, LLC, Overland Park, KS (US)

(72) Inventors: Justin Michael Oliver Wright, Olathe, KS (US); Hugh D. Brown, Olathe, KS (US)

(73) Assignee: Firemon, Overland Park, KS (US)

(21) Appl. No.: 17/514,624

(22) Filed: Oct. 29, 2021

(51) Int. Cl. H04L 29/06; H04L 12/26

(52) U.S. Cl. CPC H04L 63/0254; H04L 63/20; H04L 43/50

(57) ABSTRACT

A system obtains a domain-specific language (DSL) behavior document corresponding to a network appliance and including a plurality of functions, compiles using a lexer and parser the DSL behavior document into an abstract syntax tree (AST) including a plurality of function branches, interprets using a treewalker the plurality of function branches, chains into a composite behavior model a plurality of behavior groups respectively corresponding to the plurality of function branches based on the interpreting, and stores the composite behavior model in a database associated with the network appliance.

### TECHNICAL FIELD

The present application relates to the field of network security policy management, including emulation of network appliances.

### BACKGROUND

Modeling the behavior of a network device typically requires a network engineer subject matter expert to research and document the network device's behavior, a software developer to hardcode a plurality of behavior groups that model the network device, a network engineer subject matter expert to verify the model (a complicated and error prone process), and a support engineer to troubleshoot the model once it is released, since there are often issues when the model is executed against a real-world scenario. The support engineer often collaborates with the developer and network engineers costing time, money and effort.

### SUMMARY

A modeling system and process as disclosed herein describes the behavioral chain of a network device in a simple domain-specific language (DSL) that can be executed to construct the behavioral model chain of a given device for the benefit of rapidly prototyping and troubleshooting model device behaviors and running and maintaining behavioral model prototypes for all supported network devices under a Network Policy Security Management (NPSM) system.

Stated another way, the techniques described herein use a DSL to build a chain of generic behavior components that model vendor-specific network appliances. The DSL chains various network appliance components together in a way that can be leveraged to model vendor-specific devices.

Each behavior in the chain is represented as a function. Arguments associated with the functions are optional. The first three arguments represent the Accept, Deny, Default actions. Policy functions have an additional argument that describes the policy chaining logic. A parser-lexer builds an abstract syntax tree (AST), and a tree walker walks the AST chaining the behavior groups together.

By using a DSL as described herein, the disclosed modeling techniques can remove the software developer from the process and allow network engineers and support staff to quickly model, deploy, and verify network appliance behavior chains.

In one aspect, a system for constructing a behavior model of a network appliance, the system including one or more processors and memory storing one or more programs to be executed by the one or more processors, the one or more programs including instructions for: obtaining a domain-specific language (DSL) behavior document corresponding to the network appliance and including a plurality of functions, wherein each of the plurality of functions is associated with a behavior group of a plurality of behavior groups defining an operational characteristic of the network appliance, and at least one of the plurality of functions includes a first argument corresponding to an accept outcome, a second argument corresponding to a deny outcome, and/or a third argument corresponding to a default outcome; compiling using a lexer and parser the DSL behavior document into an abstract syntax tree (AST) including a plurality of function branches, wherein each of the plurality of function branches corresponds to a behavior group of the plurality of behavior groups associated with a respective function of the plurality of functions, and includes a behavior group pointer and one or more arguments including the first argument corresponding to the accept outcome, the second argument corresponding to the deny outcome, and/or the third argument corresponding to the default outcome; interpreting using a treewalker the plurality of function branches, including, for a first function branch of the plurality of function branches, evaluating the one or more arguments included in the first function branch and following the behavior group pointer of the first function branch, in accordance with the evaluating, to a second function branch of the plurality of function branches; chaining into a composite behavior model a plurality of behavior groups respectively corresponding to the plurality of function branches based on the interpreting; and storing the composite behavior model in a database associated with the network appliance.

In some implementations, the network appliance is a firewall, and the plurality of functions include an ingress interface function, a routing function, a policy function, and an egress interface function.

In some implementations, the firewall includes a network address translator (NAT), and the plurality of functions further include a destination NAT function and a source NAT function.

In some implementations, the accept outcome is associated with a determination that a network packet matches a first rule from a set of rules within a behavior component associated with the function branch; the deny outcome is associated with a determination that a network packet matches a second rule from the set of rules within the behavior component associated with the function branch; and the default outcome is associated with a determination that a network packet does not match any rules from the set of rules within the behavior component associated with the function branch.

In some implementations, following the behavior group pointer to the second function branch of the plurality of function branches includes: determining that a first of the one or more arguments corresponds to the accept outcome; and following the behavior group pointer associated with the first of the one or more arguments.

In some implementations, the at least one of the plurality of functions is the policy function; and the policy function includes a fourth argument corresponding to a logic expression associated with a plurality of policies.

In some implementations, the logic expression associated with the plurality of policies includes two or more logical functions; and evaluating the fourth argument of the policy function includes forgoing evaluation of at least one of the two or more logical functions based on a result of an evaluation of a first of the two or more logical functions.

In some implementations, the plurality of behavior groups of the composite behavior model are associated with one or more vendor-specific properties of the network appliance.

In some implementations, the one or more programs further include instructions for updating the composite behavior model based on a subsequently obtained DSL behavior document, wherein the updating does not involve hardcoding of the composite behavior model.

In some implementations, the one or more programs further include instructions for: generating an emulation of the network appliance based on the composite behavior model; and prototyping or troubleshooting the network appliance based on the emulation of the network appliance.

### BRIEF DESCRIPTION OF THE DRAWINGS

FIG. 1 is a block diagram of a security intelligence platform in accordance with some implementations.

FIG. 2 is a flow diagram of a security intelligence process in accordance with some implementations.

FIG. 3 is a diagram of a chain of behavior groups of a firewall device in accordance with some implementations.

FIG. 4 is a diagram of a behavior model chain document including expressions corresponding to the firewall device described in FIG. 3 in accordance with some implementations.

FIGS. 5A-5G are diagrams of an abstract syntax tree (AST) corresponding to the behavior document in FIG. 4 in accordance with some implementations.

FIG. 6 is diagram of a composite behavior model corresponding to the AST in FIG. 5 in accordance with some implementations.

FIGS. 7A-7D are diagrams of policy logic ASTs in accordance with some implementations.

FIG. 8 is a flow diagram of a composite behavior model generation process in accordance with some implementations.

Like reference numerals refer to corresponding parts throughout the several views of the drawings.

### DETAILED DESCRIPTION

Disclosed herein are various implementations of systems and methods for constructing a chain of behavior groups corresponding to a vendor-specific network appliance. The systems and methods can remove software developers from the process and allow network engineers and support engineers to quickly model, deploy, and verify a network appliance behavior chain.

Device pack developers, network engineers, and/or support engineers can use the systems and methods described herein to describe the behavioral chain of a device in a simple domain specific language (DSL) that could be executed to construct the behavioral model chain of the device. A DSL is a computer language specialized to a particular application domain. The behavior model chain describes the different behaviors of various aspects of a network appliance (e.g., including interfaces, routing, security policies, and so forth). Such aspects are chained together to emulate a vendor-specific device, for the benefit of rapidly prototyping and troubleshooting model device behaviors and running and maintaining behavioral model prototypes for all supported network devices under a Network Policy Security Management (NPSM) system.

As described in more detail below, each behavior in the chain may be represented as a function. Each function may have one or more arguments. The first three arguments may represent Accept, Deny, and Default actions. Security policy functions may have an additional argument that describes the policy chaining logic. Notably, a parser/lexer builds an abstract syntax tree (AST) from a DSL document describing various behavior groups of the device, and a treewalker walks the AST chaining the behavior groups together.

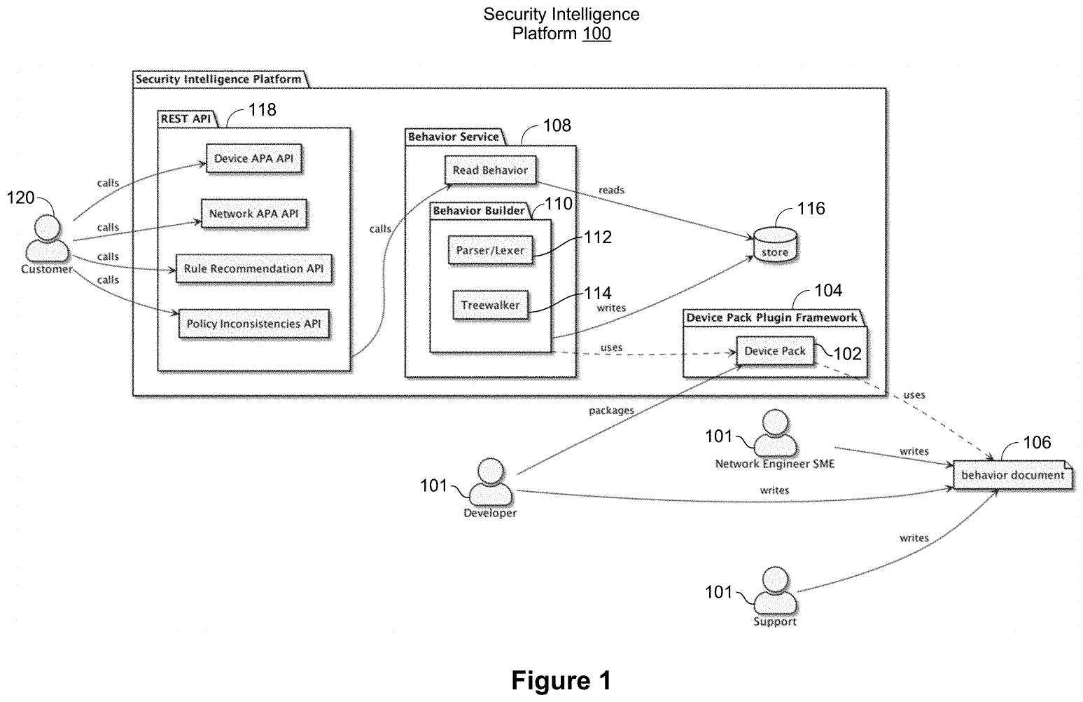

FIG. 1 is a block diagram of a security intelligence platform 100 in accordance with some implementations. Security intelligence platform 100 is built upon representational state transfer application programming interfaces (REST APIs) 118, which may be called by a customer 120. REST APIs are application programming interfaces that conform to the constraints of the REST architectural style and allow for interaction with RESTful web services.

The REST APIs 118 call an internal behavior service 108, which includes a behavior builder 110 configured to construct behavior chains using a parser/lexer 112 and treewalker 114.

The device pack plugin framework 104 describes how different network appliances are handled. This plugin framework may have a key that corresponds to behavior models that have typically been hardcoded together in a chain. The behavior builder 110, however, constructs chains without requiring any hardcoding.

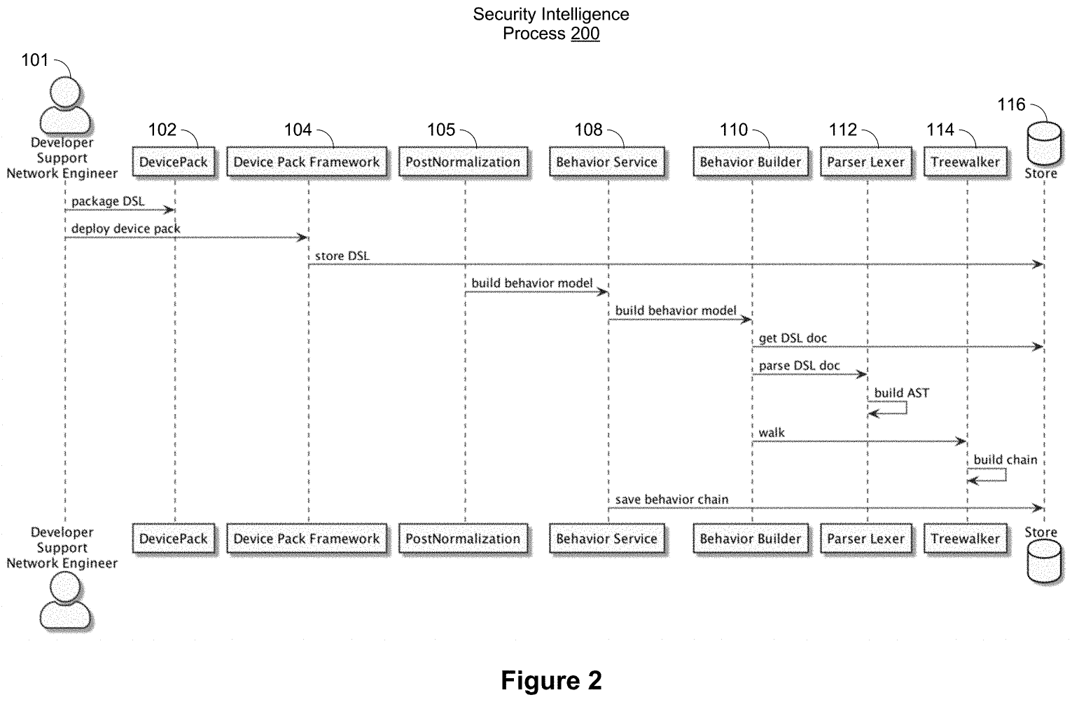

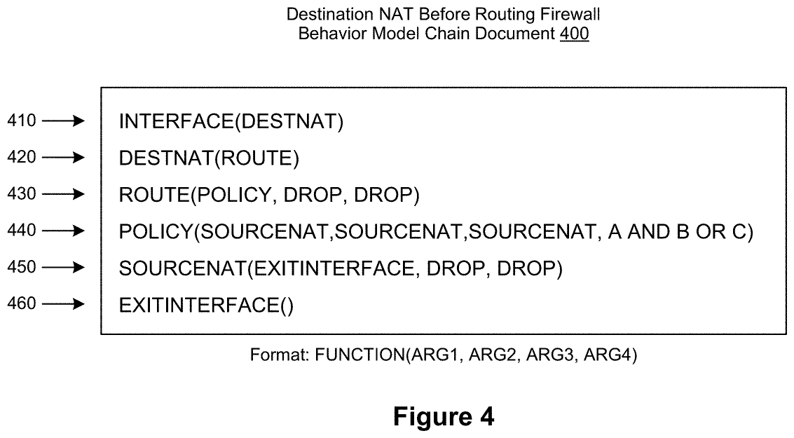

One or more network engineers, software developers, and/or support engineers 101 write a behavior document 106 using a DSL. The behavior document 106 contains the DSL that describes a particular vendor's network appliance behavior chain. The behavior document 106 is described in more detail below with reference to FIG. 4. The behavior document 106 is packaged within the framework of platform 100 (e.g., device pack framework 104, FIG. 2).

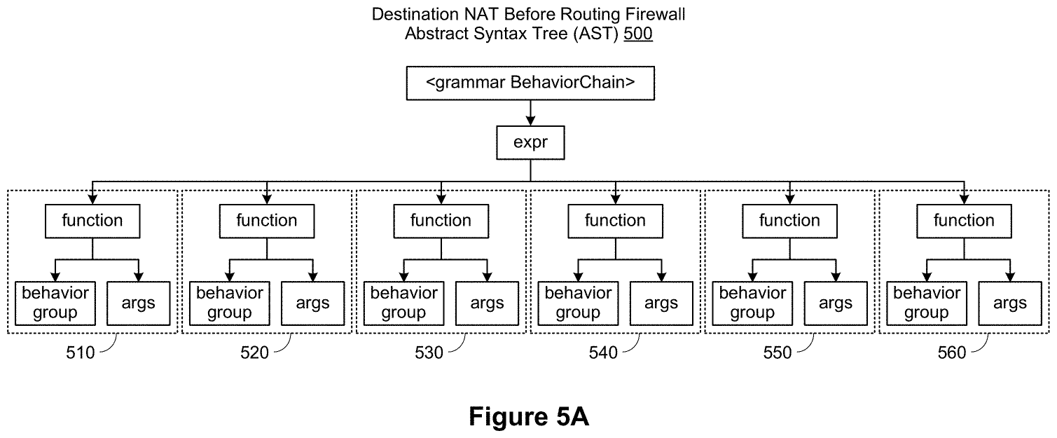

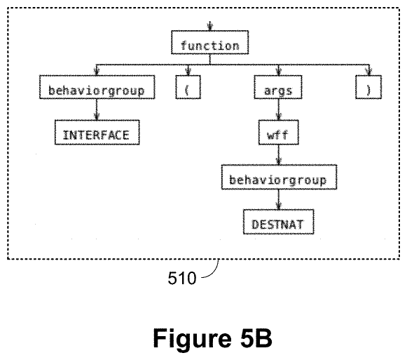

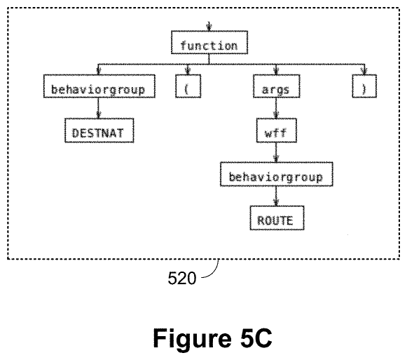

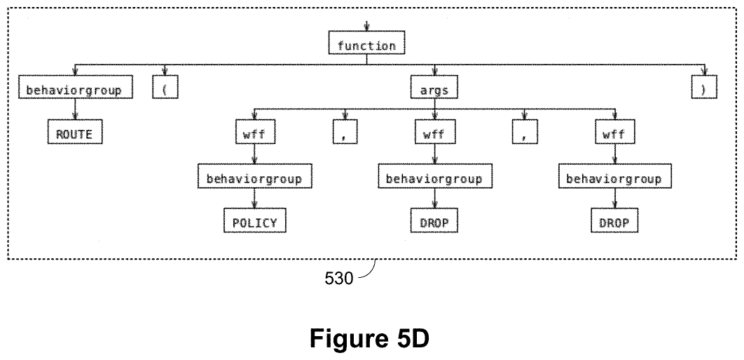

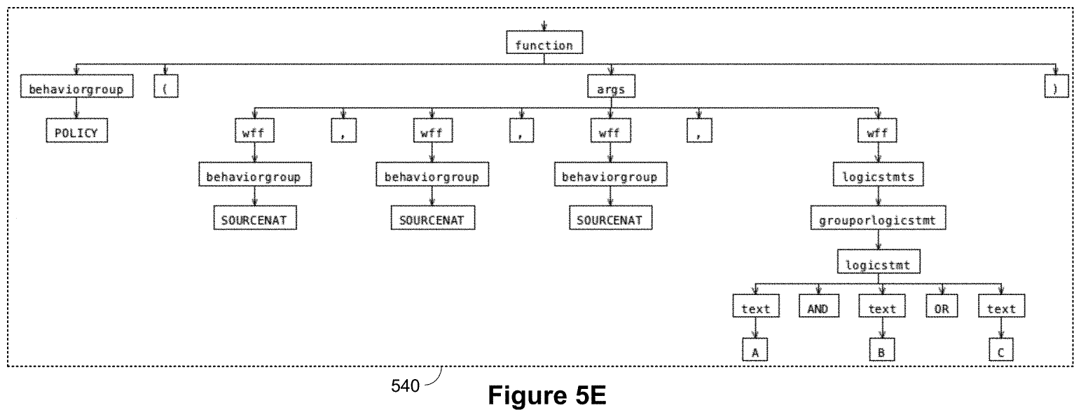

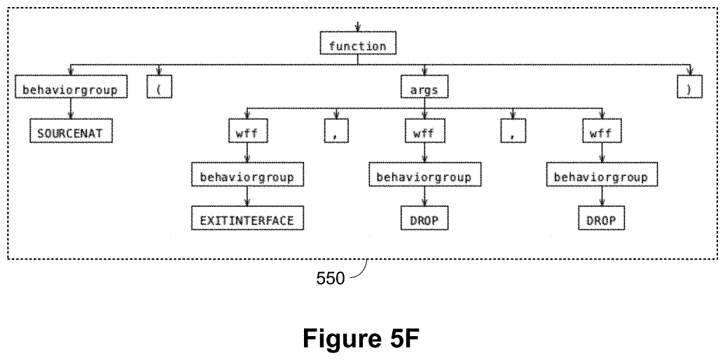

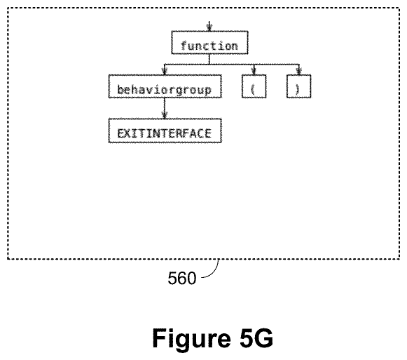

The parser/lexer 112 parses the behavior document 106 into an abstract syntax tree (AST) structure. The AST is described in more detail below with reference to FIGS. 5A-5G.

The treewalker 114 interprets the AST and aggregates pre-built behavior components into a chain of behaviors that emulates the vendor-specific network appliance. In other words, treewalker 114 compiles the AST into a behavior chain. The behavior chain is described in more detail below with reference to FIGS. 4-6.

Thus, parser/lexer 112 and treewalker 114 parse and compile a network compliance behavior chain of interfaces, policies, network address translators (NATs), routers, and/or other network-related elements, and the behavior chain may be parsed and compiled without hardcoding.

FIG. 2 is a flow diagram of a security intelligence process 200 in accordance with some implementations.

One or more network engineers, software developers, and/or support engineers 101 write the behavior document (106, FIG. 1) and package the document in a device pack 102 (a plugin package). In some implementations, the device pack is installed outside of the normal software development lifecycle.

The device pack is deployed to device pack framework module 104. Device pack framework module 104 normalizes the device pack (e.g., transforms its format into a common format) and stores the device pack in database 116. Post normalization module 105 pulls a revision from a network appliance and causes behavior service 108 to build a behavior model (a behavior component chain). Behavior service 108 uses behavior builder 110 to build the behavior model. Behavior builder 110 obtains the behavior document from database 116, causes the parser/lexer 112 to compile the behavior document into an AST, and causes the treewalker 114 to configure the AST into a behavior chain model. Behavior service 108 then stores the behavior chain model in database 116.

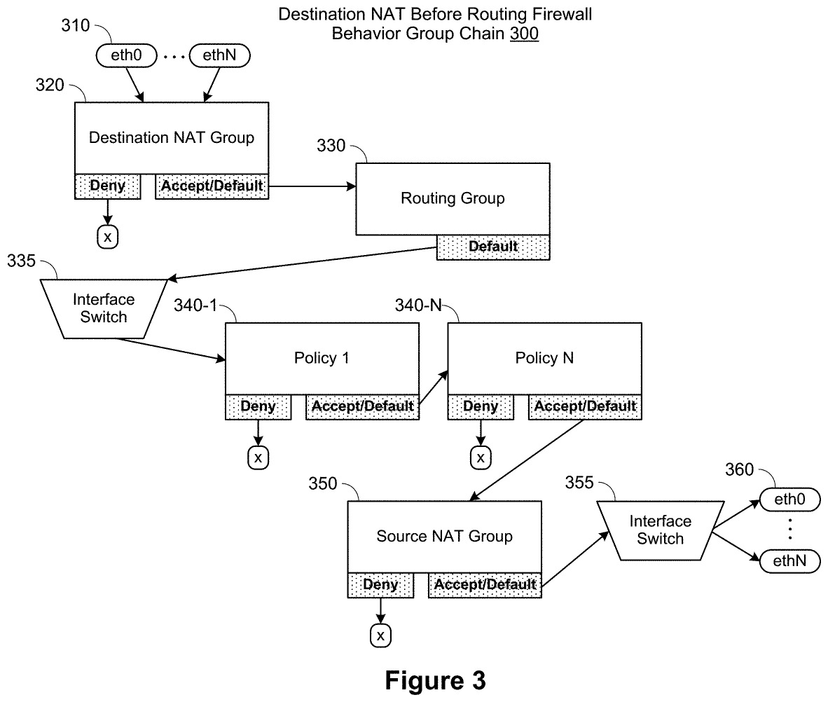

FIG. 3 is a diagram of a chain of behavior groups 300 of a firewall device in accordance with some implementations. While a firewall device (as depicted in FIG. 3) is an example network appliance that may be represented as a plurality of behavior groups, other network appliances may also be represented as a plurality of behavior groups, such as routers, switches, firewalls, and traffic management devices. Such devices can be represented as a chain of behavior components consisting of interfaces, various types of network address translation policies, security rule policies, and routing policies connected in various ways depending on vendor-specific implementations.

The behavior groups 300 include ingress interfaces 310, a destination NAT group 320, a routing group 330 (e.g., a route table), a first interface switch 335, a plurality of security policies 340-1 through 340-N, a source NAT group 350, a second interface switch 355, and egress interfaces 360. The NATs (network address translators) map IP address spaces into other address spaces by modifying network address information in the IP header of packets while the packets are in transit across the network device.

Each of the behavior components 310-360 can be represented as a function. Each function optionally has one or more arguments. The arguments of functions representing behavior components are pointers to the next behavior component in a chain of behavior components. The arguments are based on three outcomes (also referred to as actions, results, or spaces).

A first outcome is an Accept outcome, and it is applied when a network packet matches a rule (e.g., a first rule) from a set of rules within the behavior component. A second outcome is a Deny outcome, and it is applied when the network packet matches a rule (e.g., a second rule) from the set of rules within the behavior component. A third outcome is a Default outcome, and it is applied when the network packet does not match any rules from the set of rules within the behavior component.

Stated another way, coming out of a particular behavior group, there is an accept space, a deny space, and a default space. The NAT, policy, and/or routing behavior groups attempt to match a network packet based off a set of rules, and if the packet matches a rule, then there are two choices: accept or deny. If no packets are matched, then there is a default.

Stated yet another way, the first argument describes what happens if a network packet is accepted. In the event the packet is accepted, the packet is conveyed to the next behavior group, wherein the next behavior group is specified by a pointer associated with the first argument. The second argument describes what happens if a network packet is denied. In the event the packet is denied, the packet may be dropped, or the packet may be conveyed to the next behavior group, wherein the next behavior group is specified by a pointer associated with the second argument. The third argument describes what happens if a network packet defaults. In the event the packet defaults, the packet may be dropped, or the packet may be conveyed to the next behavior group, wherein the next behavior group is specified by a pointer associated with the third argument.

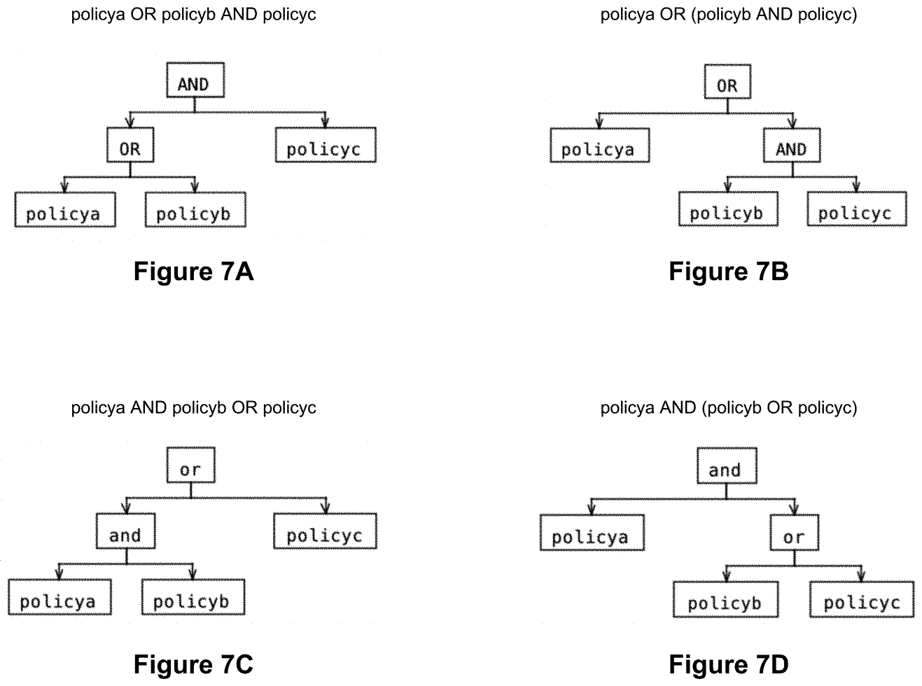

A behavior component for a security policy can be represented by a function having a fourth argument (in addition to the three arguments described above). The fourth argument expresses the logic behind evaluating chains of multiple policies within the policy behavior (e.g., policy A and policy B or policy C). When there are multiple policies (e.g., A, B, C), the ANDing and ORing of these policies could be critical in some implementations. Without a policy logic expression in such implementations, multiple policies would be evaluated one after another until a packet matched. Thus, expressing the logic of evaluating policies within the policy behavior group by using AND, OR, and NOT statements that describe the relationship of matching accept or deny spaces between policies allows for multiple policies to be evaluated without requiring them all to be evaluated one at a time. This concept is described in more detail below with reference to FIGS. 7A-7D.

FIG. 4 is a diagram of a behavior model chain document 400 including expressions corresponding to the firewall device described in FIG. 3 in accordance with some implementations. Document 400 illustrates the use of the DSL for assembling network device behaviors. Document 400 corresponds to behavior document 106 in FIG. 1.

DSL expression 410 in FIG. 4 corresponds to ingress interface 310 in FIG. 3. DSL expression 410 includes an INTERFACE function having one argument. The INTERFACE function evaluates, based on an address space on the interface, whether a network packet will be accepted (the first argument of the function). If so, then the packet is conveyed to the behavior group corresponding to the pointer associated with the first argument (DESTNAT).

DSL expression 420 in FIG. 4 corresponds to destination NAT 320 in FIG. 3. DSL expression 420 includes a DESTNAT function having one argument. The DESTNAT function NATs the destination of the packet and conveys the packet to the behavior group corresponding to the pointer associated with the first argument (ROUTE).

DSL expression 430 in FIG. 4 corresponds to routing group 330 in FIG. 3. DSL expression 430 includes a ROUTE function having three arguments. The ROUTE function evaluates whether a network packet matches a route (first argument), matches something other than the route (second argument), or does not match anything at all (third argument). If the packet matches a route, (first argument), then the packet is conveyed to the behavior group corresponding to the pointer associated with the first argument (POLICY). Otherwise, the packet is dropped in accordance with the DROP pointers associated with the second and third arguments.

DSL expression 440 in FIG. 4 corresponds to security policies 340 in FIG. 3. DSL expression 440 includes a POLICY function having four arguments. The POLICY function evaluates the packet in accordance with security policies, and conveys the packet to the behavior group corresponding to the pointer associated with the first three arguments (SOURCENAT) in accordance with the evaluation of the policy logic in the fourth argument. The evaluation of the policy logic in the fourth argument includes logical expressions (AND, OR) involving three policies (A, B, C).

DSL expression 450 in FIG. 4 corresponds to source NAT 350 in FIG. 3. DSL expression 450 includes a SOURCENAT function having three arguments. The SOURCENAT function NATs the source of the packet and conveys the packet to the behavior group corresponding to the pointer associated with the first argument (EXITINTERFACE), or drops the packet in accordance with the DROP pointers associated with the second and third arguments.

DSL expression 460 in FIG. 4 corresponds to egress interface 360 in FIG. 3. DSL expression 460 includes an EXITINTERFACE function having no arguments. The EXITINTERFACE function conveys the packet from the firewall via the egress interface 360.

Importantly, each expression 410-460 in the document 400 is written in a DSL. As such, the document may be updated (e.g., in order to change the behavior of the device that is being emulated) without hardcoding and/or without requiring a software developer to perform the update.

FIGS. 5A-5G are diagrams of an abstract syntax tree (AST) 500 corresponding to behavior document 400 in FIG. 4 in accordance with some implementations. Document 400 is compiled (using parser/lexer 112, FIGS. 1-2) into the AST in FIG. 5A. Stated another way, document 400 is expressed by the AST 500.

Referring to AST 500, a main command <grammar BehaviorChain> causes a set of arguments to be passed to an expression (expr) block. Each argument may be a separate token of an expression.

Each function corresponds to (i) a behavior group associated with a pointer, and (ii) one or more (or zero) arguments (args). As described above, depending on the function, there may be no arguments, one argument, two arguments, three arguments, four arguments, or more than four arguments.

Each function 510-560 forms a branch of the AST (also referred to as a function branch) and is respectively associated with an expression 410-460 (FIG. 4). FIGS. 5B-5G illustrate more detailed depictions of function branches 510-560, respectively.

Function branch 510 (FIG. 5B) is compiled from DSL expression 410 in FIG. 4. Function branch 510 includes a behavior group leaf node corresponding to the INTERFACE function, and an argument leaf node including one argument, which is associated with a pointer conveying the packet to DESTNAT.

Function branch 520 (FIG. 5C) is compiled from DSL expression 420 in FIG. 4. Function branch 520 includes a behavior group leaf node corresponding to the DESTNAT function, and an argument leaf node including one argument, which is associated with a pointer conveying the packet to ROUTE.

Function branch 530 (FIG. 5D) is compiled from DSL expression 430 in FIG. 4. Function branch 530 includes a behavior group leaf node corresponding to the ROUTE function, and an argument leaf node including three arguments, which are respectively associated with pointers conveying the packet to POLICY or dropping the packet.

Function branch 540 (FIG. 5E) is compiled from DSL expression 440 in FIG. 4. Function branch 540 includes a behavior group leaf node corresponding to the POLICY function, and an argument leaf node including four arguments, three of which are respectively associated with pointers conveying the packet to SOURCENAT. A fourth argument includes a chain of logical expressions for three security policies A, B, C. Inside this chain, each interface may be mapped to every other interface in the device in a policy route. The policy route may list the policies that would be affected by traffic flowing from the ingress interface 310 (FIG. 3) to the egress interface 360 (FIG. 3). Stated another way, the police route determines which policies apply to a particular packet, given the route (from ingress to egress) that is presented for the particular packet.

Function branch 550 (FIG. 5F) is compiled from DSL expression 450 in FIG. 4. Function branch 550 includes a behavior group leaf node corresponding to the SOURCENAT function, and an argument leaf node including three arguments, which are respectively associated with pointers conveying the packet to EXITINTERFACE or dropping the packet.

Function branch 560 (FIG. 5G) is compiled from DSL expression 460 in FIG. 4. Function branch 560 includes a behavior group leaf node corresponding to the EXITINTERFACE function, and no arguments.

For each function branch, the arguments are associated with pointers to the next function, so the function branches do not necessarily need to be compiled in the order depicted in FIGS. 5A-5G.

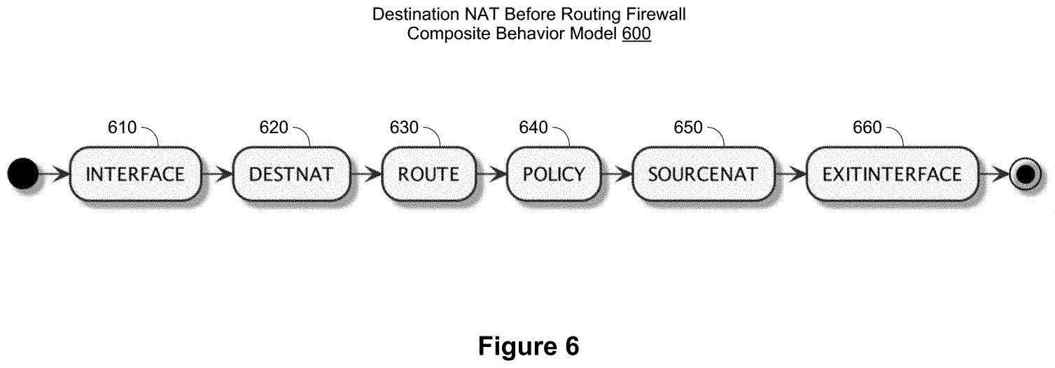

FIG. 6 is diagram of a composite behavior model 600 (also referred to as a behavior chain) corresponding to the AST in FIG. 5 in accordance with some implementations. The treewalker 114 (FIGS. 1-2), also referred to as an interpreter, walks the AST 500 (FIGS. 5A-5G) and chains the components together into the composite behavior model 600. Each chain component 610-660 respectively corresponds to a function branch 510-560 of AST 500.

In some embodiments, for each function branch, the treewalker 114 walks down the left side of the branch (e.g., behaviorgroup>INTERFACE in FIG. 5B), then back up to the top of the branch and down the next column of the branch (e.g., args>wff>behaviorgroup>DESTNAT in FIG. 5B), in order to build the behavior chain 600. Stated another way, in the example referring to FIG. 5B, treewalker 114 starts by using the INTERFACE behavior group, then determining what the INTERFACE behavior group chains to next. For an accept space, the INTERFACE behavior group chains to the DESTNAT behavior group next. In some embodiments, the parentheses and commas in the arguments may be ignored. Instead, the bottom of each leaf node is what is actually interpreted by the treewalker 114.

FIGS. 7A-7D are diagrams of policy logic ASTs in accordance with some implementations. As described above, behavior components for security policy behaviors may be associated with an additional argument (e.g., a fourth argument) that expresses the logic behind evaluating chains of multiple policies within the policy behavior (e.g., A and B or C). When there are multiple policies, the ANDing and ORing of those policies could be critical. Without a policy logic expression in such implementations, multiple policies would be evaluated one after another until a packet matched. Thus, expressing the logic of evaluating policies within the policy behavior group by using AND, OR, and NOT statements that describe the relationship of matching accept or deny spaces between policies allows for multiple policies to be evaluated without requiring them all to be evaluated one at a time.

Using ASTs, the treewalker 114 can go down each column, and if the first side is false (for an AND statement) or if a first side is true (for an OR statement), then the treewalker 114 does not have to evaluate the second side. Stated another way, the treewalker 114 may stop processing the logical expression chain if the first side of an AND statement is false (since the result will always be false in this scenario), or if the first side of an OR statement is true (since the result will always be true in this scenario).

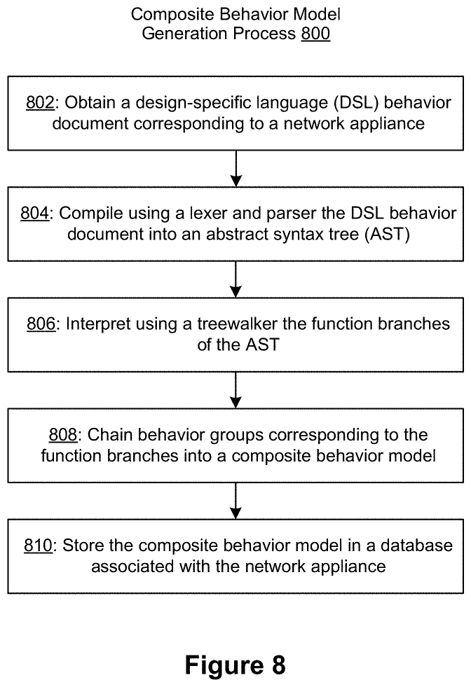

FIG. 8 is a flow diagram of a composite behavior model generation process 800 in accordance with some implementations. Process 800 is, optionally, governed by instructions that are stored in a computer memory or non-transitory computer readable storage medium and that are executed by one or more processors. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in process 800 may be combined and/or the order of some operations may be changed.

In process 800, a system (e.g., 100, FIG. 1) for constructing a behavior model (e.g., 600, FIG. 6) of a network appliance (e.g., a router or a firewall) includes one or more processors and memory storing one or more programs to be executed by the one or more processors. The one or more programs including instructions for executing one or more of operations 802-810.

In operation 802, the system obtains a domain-specific language (DSL) behavior document (e.g., 400, FIG. 4) corresponding to the network appliance and including a plurality of functions (e.g., 410-460), wherein each of the plurality of functions is associated with a behavior group of a plurality of behavior groups (e.g., 310-360) defining an operational characteristic of the network appliance, and at least one of the plurality of functions includes a first argument corresponding to an accept outcome, a second argument corresponding to a deny outcome, and/or a third argument corresponding to a default outcome.

In operation 804, the system compiles using a lexer and parser (e.g., 112, FIGS. 1-2) the DSL behavior document into an abstract syntax tree (AST) (e.g., 500, FIG. 5A) including a plurality of function branches (e.g., 510-560, FIG. 5A), wherein each of the plurality of function branches corresponds to a behavior group of the plurality of behavior groups associated with a respective function of the plurality of functions, and includes a behavior group pointer and one or more arguments including the first argument corresponding to the accept outcome, the second argument corresponding to the deny outcome, and/or the third argument corresponding to the default outcome.

In operation 806, the system interprets using a treewalker (e.g., 114, FIGS. 1-2) the plurality of function branches, including, for a first function branch of the plurality of function branches, evaluating the one or more arguments included in the first function branch and following the behavior group pointer of the first function branch, in accordance with the evaluating, to a second function branch of the plurality of function branches. For example, referring to FIG. 5B, the system evaluates the argument (args) and follows the behavior group pointer DESTNAT to function branch 520 (FIG. 5C) corresponding to the DESTNAT function.

In operation 808, the system chains into a composite behavior model (e.g., 600, FIG. 6) a plurality of behavior groups respectively corresponding to the plurality of function branches based on the interpreting. For example, the system chains behavior group 520 (FIG. 5C) to behavior group 510 (FIG. 5B) based on the evaluation of the argument as described in operation 806.

In operation 810, the system stores the composite behavior model in a database (e.g., 116, FIG. 2) associated with the network appliance.

In some implementations, the network appliance is a firewall, and the plurality of functions include an ingress interface function, a routing function, a policy function, and an egress interface function.

In some implementations, the firewall includes a network address translator (NAT), and the plurality of functions further include a destination NAT function and a source NAT function.

In some implementations, the accept outcome is associated with a determination that a network packet matches a first rule from a set of rules within a behavior component associated with the function branch; the deny outcome is associated with a determination that a network packet matches a second rule from the set of rules within the behavior component associated with the function branch; and the default outcome is associated with a determination that a network packet does not match any rules from the set of rules within the behavior component associated with the function branch.

In some implementations, following the behavior group pointer to the second function branch of the plurality of function branches includes: determining that a first of the one or more arguments corresponds to the accept outcome; and following the behavior group pointer associated with the first of the one or more arguments.

In some implementations, the at least one of the plurality of functions is the policy function; and the policy function includes a fourth argument corresponding to a logic expression associated with a plurality of policies.

In some implementations, the logic expression associated with the plurality of policies includes two or more logical functions; and evaluating the fourth argument of the policy function includes forgoing evaluation of at least one of the two or more logical functions based on a result of an evaluation of a first of the two or more logical functions.

In some implementations, the plurality of behavior groups of the composite behavior model are associated with one or more vendor-specific properties of the network appliance.

In some implementations, the one or more programs further include instructions for updating the composite behavior model based on a subsequently obtained DSL behavior document, wherein the updating does not involve hardcoding of the composite behavior model.

In some implementations, the one or more programs further include instructions for: generating an emulation of the network appliance based on the composite behavior model; and prototyping or troubleshooting the network appliance based on the emulation of the network appliance

In some implementations, the techniques described herein use a DSL to build a chain of generic behavior components that model vendor-specific network appliances. Vendors may chain the behavior components in slightly different ways based on vendor specifications. Thus, the techniques described herein provide the ability to quickly chain these different components in various ways to emulate vendor-specific network appliances using a simple language. This provides flexibility and maintainability of behavior chaining and policy route evaluation. Further, use of a DSL as described herein allows device packs to specify policies in a policy route and to be able to modify the behavior without an overall system release.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims.

For example, specific features of the exemplary embodiments may or may not be part of the claimed invention, different components as opposed to those specifically mentioned may perform at least some of the features described herein, and features of the disclosed embodiments may be combined.

As used herein, the terms “about” and “approximately” may refer to + or −10% of the value referenced. For example, “about 9” is understood to encompass 8.2 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

It will be understood that, although the terms “first,” “second,” etc. are sometimes used herein to describe various elements, these elements should not be limited by these terms. These terms are only used to distinguish one element from another.

For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

As used herein, the term “if” may be, optionally, construed to mean “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The terminology used herein is for the purpose of describing particular implementations only and is not intended to be limiting of the claims.

As used in the description of the implementations and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items.

It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context.

Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A system for constructing a behavior model of a network appliance, the system including one or more processors and memory storing one or more programs to be executed by the one or more processors, the one or more programs including instructions for:
obtaining a domain-specific language (DSL) behavior document corresponding to the network appliance and including a plurality of functions, wherein each of the plurality of functions is associated with a behavior group of a plurality of behavior groups defining an operational characteristic of the network appliance, and at least one of the plurality of functions includes a first argument corresponding to an accept outcome, a second argument corresponding to a deny outcome, and/or a third argument corresponding to a default outcome;
compiling using a lexer and parser the DSL behavior document into an abstract syntax tree (AST) including a plurality of function branches, wherein each of the plurality of function branches corresponds to a behavior group of the plurality of behavior groups associated with a respective function of the plurality of functions, and includes a behavior group pointer and one or more arguments including the first argument corresponding to the accept outcome, the second argument corresponding to the deny outcome, and/or the third argument corresponding to the default outcome;
interpreting using a treewalker the plurality of function branches, including, for a first function branch of the plurality of function branches, evaluating the one or more arguments included in the first function branch and following the behavior group pointer of the first function branch, in accordance with the evaluating, to a second function branch of the plurality of function branches;
chaining into a composite behavior model a plurality of behavior groups respectively corresponding to the plurality of function branches based on the interpreting; and
storing the composite behavior model in a database associated with the network appliance.

2. The system of claim 1, wherein the network appliance is a firewall, and the plurality of functions include an ingress interface function, a routing function, a policy function, and an egress interface function.

3. The system of claim 2, wherein the firewall includes a network address translator (NAT), and the plurality of functions further include a destination NAT function and a source NAT function.

4. The system of claim 3, wherein:
the accept outcome is associated with a determination that a network packet matches a first rule from a set of rules within a behavior component associated with the function branch;
the deny outcome is associated with a determination that a network packet matches a second rule from the set of rules within the behavior component associated with the function branch; and
the default outcome is associated with a determination that a network packet does not match any rules from the set of rules within the behavior component associated with the function branch.

5. The system of claim 4, wherein following the behavior group pointer to the second function branch of the plurality of function branches includes:
determining that a first of the one or more arguments corresponds to the accept outcome; and
following the behavior group pointer associated with the first of the one or more arguments.

6. The system of claim 5, wherein:
the at least one of the plurality of functions is the policy function; and
the policy function includes a fourth argument corresponding to a logic expression associated with a plurality of policies.

7. The system of claim 6, wherein:
the logic expression associated with the plurality of policies includes two or more logical functions; and
evaluating the fourth argument of the policy function includes forgoing evaluation of at least one of the two or more logical functions based on a result of an evaluation of a first of the two or more logical functions.

8. The system of claim 7, wherein the plurality of behavior groups of the composite behavior model are associated with one or more vendor-specific properties of the network appliance.

9. The system of claim 8, wherein the one or more programs further include instructions for updating the composite behavior model based on a subsequently obtained DSL behavior document, wherein the updating does not involve hardcoding of the composite behavior model.

10. The system of claim 9, wherein the one or more programs further include instructions for:
generating an emulation of the network appliance based on the composite behavior model; and
prototyping or troubleshooting the network appliance based on the emulation of the network appliance.

11. A method for constructing a behavior model of a network appliance, the method comprising:
obtaining a domain-specific language (DSL) behavior document corresponding to the network appliance and including a plurality of functions, wherein each of the plurality of functions is associated with a behavior group of a plurality of behavior groups defining an operational characteristic of the network appliance, and at least one of the plurality of functions includes a first argument corresponding to an accept outcome, a second argument corresponding to a deny outcome, and/or a third argument corresponding to a default outcome;
compiling using a lexer and parser the DSL behavior document into an abstract syntax tree (AST) including a plurality of function branches, wherein each of the plurality of function branches corresponds to a behavior group of the plurality of behavior groups associated with a respective function of the plurality of functions, and includes a behavior group pointer and one or more arguments including the first argument corresponding to the accept outcome, the second argument corresponding to the deny outcome, and/or the third argument corresponding to the default outcome;
interpreting using a treewalker the plurality of function branches, including, for a first function branch of the plurality of function branches, evaluating the one or more arguments included in the first function branch and following the behavior group pointer of the first function branch, in accordance with the evaluating, to a second function branch of the plurality of function branches;
chaining into a composite behavior model a plurality of behavior groups respectively corresponding to the plurality of function branches based on the interpreting; and
storing the composite behavior model in a database associated with the network appliance.

12. The method of claim 11, wherein the network appliance is a firewall, and the plurality of functions include an ingress interface function, a routing function, a policy function, and an egress interface function.

13. The method of claim 12, wherein the firewall includes a network address translator (NAT), and the plurality of functions further include a destination NAT function and a source NAT function.

14. The method of claim 13, wherein:
the accept outcome is associated with a determination that a network packet matches a first rule from a set of rules within a behavior component associated with the function branch;
the deny outcome is associated with a determination that a network packet matches a second rule from the set of rules within the behavior component associated with the function branch; and
the default outcome is associated with a determination that a network packet does not match any rules from the set of rules within the behavior component associated with the function branch.

15. The method of claim 14, wherein following the behavior group pointer to the second function branch of the plurality of function branches includes:
determining that a first of the one or more arguments corresponds to the accept outcome; and
following the behavior group pointer associated with the first of the one or more arguments.

16. The method of claim 15, wherein:
the at least one of the plurality of functions is the policy function; and
the policy function includes a fourth argument corresponding to a logic expression associated with a plurality of policies.

17. The method of claim 16, wherein:
the logic expression associated with the plurality of policies includes two or more logical functions; and
evaluating the fourth argument of the policy function includes forgoing evaluation of at least one of the two or more logical functions based on a result of an evaluation of a first of the two or more logical functions.

18. The method of claim 17, wherein the plurality of behavior groups of the composite behavior model are associated with one or more vendor-specific properties of the network appliance.

19. The method of claim 18, further comprising updating the composite behavior model based on a subsequently obtained DSL behavior document, wherein the updating does not involve hardcoding of the composite behavior model.

20. The method of claim 19, further comprising:
generating an emulation of the network appliance based on the composite behavior model; and
prototyping or troubleshooting the network appliance based on the emulation of the network appliance.
